(19) United States
(12) Patent Application Publication
(10) Pub. No.: US 2015/0377291 A1
(43) Pub. Date: Dec. 31, 2015

(54) CAGE PART FOR A ROLLING BEARING CAGE

(71) Applicant: SCHAEFFLER TECHNOLOGIES AG & CO. KG, Herzogenaurach (DE)

(72) Inventors: Horst Masuch, Schweinfurt (DE); Hermann Geyer, Vestenbergsgreuth (DE); Roland Eichler, Herzogenaurach (DE); Florian Vogelgesang, Hemhofen (DE); Sabine Plischki, Donnersdorf (DE); Manuel Rettinger, Oerlenbach (DE); Manfred Jansen, Weisendorf (DE); Christian Seubert, Oberleichtersbach (DE); Christoph Meder, Sulzfeld (DE); Lorenz Bell, Erlangen (DE)

(73) Assignee: Schaeffler Technologies AG & Co. KG, Herzogenaurach (DE)

(21) Appl. No.: 14/767,757

(22) PCT Filed: Feb. 3, 2014
(86) PCT No.: PCT/DE2014/200037

§ 371 Date: Aug. 13, 2015

(30) Foreign Application Priority Data
Feb. 28, 2013 (DE) 10 2013 203 382.6

(51) Int. Cl. F16C 33/50; F16C 33/54

(52) U.S. Cl. CPC F16C 33/508; F16C 33/548

(57) ABSTRACT

A cage part (1, 20, 40) for a rolling bearing cage (30), having a connecting part (3) extending in a longitudinal direction (Z), at the ends of which a first supporting arm (4) and a second supporting arm (5) are arranged, each of which extends beyond the connecting part (3) on both sides in a first transverse direction (X) perpendicular to the longitudinal direction (Z). The supporting arms (4, 5) each include two half arms (7, 8, 9, 10) angled in the opposite direction to one another away from the web (3) and which are offset with respect to one another in a second transverse direction (Y) perpendicular to the first transverse direction (X) and the longitudinal direction (Z).

### FIELD OF THE INVENTION

The invention relates to a cage part for a rolling bearing cage, with a connecting bar that extends in the longitudinal direction and has, on its ends, a first support arm and a second support arm that each extend in a first transverse direction perpendicular to the longitudinal direction on both sides beyond the connecting bar. The invention further relates to a rolling bearing cage that is comprised from a plurality of the cage parts specified above.

### BACKGROUND

In large rolling bearings, for spacing and guiding the rolling bodies, the use of a so-called pin cage is known in practice, as shown in DE 10 2004 025 796 A1. A disadvantage is that such a pin cage can be manufactured and also installed only with much expense. In addition, in a pin cage, the rolling bodies must be drilled so that these can be kept at a distance with the help of the pins.

Alternatively, for spacing the rolling bodies in a rolling bearing, it is also known to use so-called spacers between the rolling bodies. Such spacers are described, for example, in DE 10 2009 016 017 B4. A disadvantage, however, is that, with large rolling bearings with heavy rolling bodies and for a horizontal orientation of the shaft, such spacers result in undesired jamming of rolling bodies. For slow rotation, individual rolling bodies remain within the limits of the operational clearance and are then supported on adjacent rolling bodies. This can result in the jamming of a rolling body. Depending on the load, this rolling body can slip and slide or rotate in the rolling bearing. The slipping of a rolling body under load, however, must be avoided in a rolling bearing, because this causes undesired wear in the raceway.

In DE 1 207 719 A, spacers with an H-shape for guiding and spacing rolling bodies are known. By the use of these spacers, adjacent rolling bodies are prevented from being supported one on another. For this purpose, the spacers are guided in ring-shaped side parts at a distance to each other. In the scope of the operating play, it is not possible for a rolling body to push a spacer onto the adjacent rolling body. If the spacers guided in the side ring push against each other, there is still play in the cage pocket that is formed for the rolling body in the circumferential direction. A disadvantage in this solution, however, is that the H-shaped spacers must be mounted for guidance with two additional side parts.

The invention is based on the objective of providing a cage part of the type noted above, with which an alternative rolling bearing cage for guiding and keeping rolling bodies at a distance from each other can be formed in a simple and economical way.

### SUMMARY

The stated objective is achieved according to the invention for a cage part with a connecting part extending in a longitudinal direction, wherein a first supporting arm and a second supporting arm are arranged on the ends of this connecting part and each extend in a first transverse direction perpendicular to the longitudinal direction beyond the connecting part on both sides, in that the supporting arms each comprise two half arms that are angled away from the connecting part opposite each other and are offset relative to each other in a second transverse direction perpendicular to the first transverse direction and to the longitudinal direction.

The specified cage part can be produced economically from a sheet metal strip whose ends are separated into two sections parallel to each other. In the finished cage part, the two sections are bent away from each other in opposite directions at each end of the sheet metal strip. An essentially H-shaped cage part is produced, wherein the two side arms of the H (called supporting arms) are each formed with two separate half arms (the sections of the sheet metal strip bent opposite each other) that are offset relative to each other perpendicular to the viewing plane of the H (in second transverse direction). By way of the offset of the two half arms in the second transverse direction, it is possible to guide the cage part between an inner ring and an outer ring of a rolling bearing supported on the rim. Here, a half arm of a supporting arm is guided on the inner ring and the other half arm of the supporting arm is guided on the outer ring. Additional side parts for guiding and fastening the cage parts are not required. The connecting part of the cage part is oriented in the mounted state with its longitudinal direction in the axial direction of the rolling bearing.

A half pocket for holding each rolling body is formed between the half arms bent in the same direction on the first and second supporting arms of each cage part. For the assembly of the cage parts into a rolling bearing cage, the half pockets of adjacent cage parts expand into a complete cage pocket. In the circumferential direction, the connecting parts of each cage part form the boundary for the rolling bodies held in the cage pockets.

The invention is suitable both for tapered rolling bearings and also for cylindrical rolling bearings. In particular, the invention can be used for large rolling bearings with heavy rolling bodies and with a high load rating, like those required, for example, for supporting a rotor on the housing of a wind turbine.

In one preferred construction, the half arms bent in the same direction on the first and second supporting arms are offset relative to each other in the second transverse direction. This construction produces a mechanically stable setup of the rolling bearing cage assembled from the cage parts. Furthermore, with this construction, each rolling body is guided diagonally between the offset half arms of opposing supporting arms.

For guiding the rolling bodies with low friction, advantageously contour elements that extend in the longitudinal direction are formed on the half arms, wherein the contour elements of the half arms of the first supporting arm and the second supporting arm are oriented relative to each other. The rolling body is guided with its end faces between the contour elements of opposing half arms. In a complete cage pocket produced by two adjacent cage parts, each rolling body is guided on its end faces by two contour elements that are allocated to the half arm of one cage part and the half arm of the other cage part.

Preferably, for guiding and keeping the rolling bodies at a distance from each other, a number of contour elements extending in the first transverse direction can also be formed on the connecting part of the cage part. In particular, these contour elements are preferably arranged in an alternating pattern, so that the connecting part of each cage part guides a first rolling body in the circumferential direction over a contour element and an adjacent second rolling body over a contour element formed in the opposite direction.

Preferably, the specified contour elements are formed as impressions into the cage part.

In one especially preferred construction, the half arms have, along the first transverse direction, a length that is greater than the diameter of a rolling body to be held in the rolling bearing cage. In a rolling bearing cage assembled from a plurality of cage parts of this construction, the half arms of the cage parts are each supported on the connecting parts of the adjacent cage parts. Between the connecting parts of adjacent cage parts, a cage pocket with an extent in the circumferential direction is formed that is greater than the diameter of the rolling body. For each rolling body there is play in the circumferential direction, so that the clamping or support of successive rolling bodies is reliably prevented.

Advantageously, the half arms of the supporting arms are each bent away from the connecting part over a bending area. The radius of this bending area can be selected based on the material used for the cage part, in particular, based on the material hardness or the material thickness.

In a more preferred way, the bending areas extend in the longitudinal direction over a straight-line section of the connecting part and are bent back such that each bent half arm, projected in the first transverse direction, intersects the straight-line section of the connecting part. This construction has the advantage that, in a rolling bearing cage assembled from a plurality of cage parts of this construction, the half arms of the cage parts are not directly supported on the bending areas but instead on the straight line sections of the connecting parts of adjacent cage parts. Thus, in the circumferential direction, the force is introduced on a straight surface, so that no transverse forces act on the individual cage parts.

Preferably, a reinforcement rib is formed in the bending areas of the half arms. When the rolling bearing cage is operating, this reinforcement rib counteracts deformation of the bending areas even if large forces are applied.

In another preferred construction, the half arms are each expanded in an arc shape in the second transverse direction in some sections, wherein the arc-shaped sections of the half arms of one supporting arm are arranged turned away from each other. The arc-shaped sections act as guide elements in a rim guide of the cage parts on the inner ring and on the outer ring of the rolling bearing. By this rounding, the contact surface of the cage parts on the inner ring or on the outer ring can be optimized.

Incidentally it must be emphasized that the guidance of the cage parts or a rolling bearing cage assembled from a plurality of cage parts is performed by means of the respective half arms outside of the raceway for the rolling bodies. This advantageously affects the service life of the rolling bearing.

The task stated above is also achieved according to the invention by a rolling bearing cage that is assembled from a plurality of cage parts noted above, wherein the cage parts are arranged in series one after the other with the axial orientation of the connecting parts in the circumferential direction, such that the half arms of the first supporting arm and the second supporting arm of adjacent cage parts are adjacent in the radial direction.

In the rolling bearing cage assembled from the cage parts, each cage pocket is formed for a rolling body by four half arms of two adjacent cage parts.

Advantageous refinements of the rolling bearing cage are produced from the advantageous refinements of the cage part. The advantages listed above for the refinements of the cage parts can here be transferred analogously to the rolling bearing cage.

### BRIEF DESCRIPTION OF THE DRAWINGS

Embodiments of the invention will be explained in more detail with reference to a drawing. Shown are:

FIG. 1 in a perspective diagram, a cage part for a rolling bearing cage according to a first variant,

FIG. 2 in a perspective diagram, a cage part for a rolling bearing cage in a second variant, and

FIG. 3 in a perspective partial view, a rolling bearing cage assembled from a plurality of cage parts of a third variant with inserted rolling bodies.

### DETAILED DESCRIPTION OF THE PREFERRED EMBODIMENTS

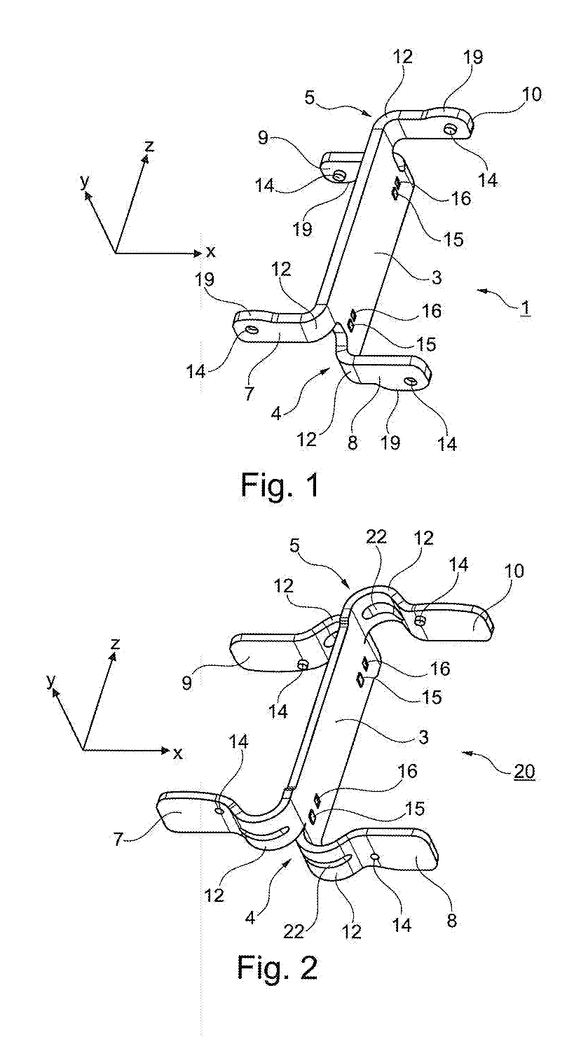

FIG. 1 shows, in a perspective view, a cage part 1 for a rolling bearing cage. The illustrated cage part 1 is made from a sheet metal strip and comprises a connecting part 3 that extends in a longitudinal direction Z, with a first supporting arm 4 and a second supporting arm 5 being arranged at the ends of this connecting part. The two supporting arms 4, 5 extend in a first transverse direction X perpendicular to the longitudinal direction Z and each comprise two half arms 7, 8 and 9, 10 that are angled away from the connecting part 3 opposite each other and are offset relative to each other in a second transverse direction Y perpendicular to the first transverse direction X and to the longitudinal direction Z. The illustrated cage part 1 essentially has an H-shape. The half arms 7, 8, 9, 10 are produced by opposite bending of the divided ends of the sheet metal strip.

The half arms 7, 9 and 8, 10 that extend in the same direction on opposite side arms 4 and 5, respectively, are also offset relative to each other in the second transverse direction Y. A half pocket for holding a rolling body is formed between the first half arm 7 and the third half arm 9 and also between the second half arm 8 and the fourth half arm 10 of respective opposing supporting arms 4 and 5. If several of the illustrated cage parts 1 are arranged in series in the circumferential direction or approximately along the first transverse direction X, then the four half arms 7, 8, 9, 10 of adjacent cage parts 1 form a complete cage pocket. Here, the first half arm 7 and the third half arm 9 are allocated to a first cage part 1 and the second half arm 8 and the fourth half arm 10 are allocated to a second cage part 1.

A rolling body inserted into a complete cage pocket formed from two adjacent cage parts 1 is guided with its end faces over contour elements 14 formed on the half arms 7, 8, 9, 10. On the connecting part 3 of a cage part 1, the inserted rolling body contacts the contour elements 15, 16 arranged in an alternating pattern and extending in the first transverse direction X. The impressed contour elements 15 extend to the right and the impressed contour elements 16 extend to the left in the drawing on connecting part 3.

The half arms 7, 8, 9, 10 are angled away from the connecting part 3 over bending areas 12. The half arms 7, 8 and 9, 10 of the first supporting arm 4 and the second supporting arm 5 each have arc-shaped sections 19 expanded turned away from each other in the second transverse direction Y. The shown cage part 1 is guided in a rolling body on an inner ring and on an outer ring over the arc-shaped, expanded sections 19.

In FIG. 2, a cage part 20 is shown in a second variant in a perspective diagram. Parts of the cage part 20 corresponding to the cage part 1 are here designated with the same reference symbols.

The bending areas 12 of the cage part 20 extend, in contrast to the bending areas 12 of the cage part 1, in the longitudinal direction Z over the straight-line section of the connecting part 3 and are then bent back, so that the half arms 7, 8, 9, 10, projected in the first transverse direction X, intersect the straight-line section of the connecting part 3. This variant has the advantage that the half arms 7, 8, 9, 10 of a cage part 20 are supported in an assembled rolling bearing cage on a straight-line surface of the connecting parts 3 of adjacent cage parts 20. To hold the forces occurring in the circumferential direction during operation, each bending area 12 also comprises a reinforcement rib 22. The length of the half arms 7, 8, 9, 10 in the first transverse direction X is greater than the diameter of a rolling body. This results in play in the cage pocket for the rolling body in the circumferential direction, so that jamming of individual rolling bodies is prevented.

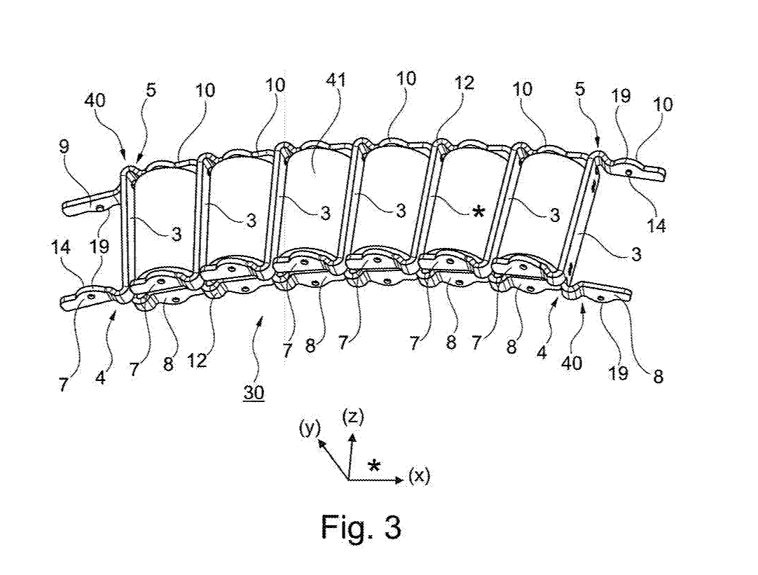

In a perspective partial view in FIG. 3, a rolling bearing cage 30 is shown as produced by series arrangement of the cage parts 40 that are formed essentially corresponding to the cage parts 20 according to FIG. 2. In contrast to the cage part 20 according to FIG. 2, however, the half arms 7, 8, 9, 10 of the cage part 40 according to FIG. 3 each have arc-shaped, rounded sections 19 by means of which the resulting rolling bearing cage 30 is guided on an inner ring and on an outer ring of a rolling bearing.

Also for the cage part 40 according to FIG. 3, the length of the half arms 7, 8, 9, 10 in the first transverse direction X is greater than the diameter of the rolling bodies 41 between the cage parts 40. It can be seen that the cage parts 40 in series one after the other are supported with their half arms 7, 8, 9, 10 on the connecting parts 3 of adjacent cage parts 40. Play is produced in the circumferential direction for each rolling body 41, so that clamping or supporting of adjacent rolling bodies 41 is prevented during operation of the rolling bearing cage 30.

The connecting parts 3 of the individual cage parts 40 extend according to FIG. 3 in the formed rolling bearing cage 30 with their longitudinal direction in the axial direction. The half arms 7, 8, 9, 10 are oriented approximately tangentially to the circumferential direction. The second transverse direction Y corresponds to the radial direction.

The coordinate system shown in FIG. 3 again shows the corresponding directions. With the coordinate system, reference is made to the cage part 40 marked with an asterisk. The longitudinal direction Z of the cage part 40 corresponds to the axial direction of the rolling bearing cage 40 or an imaginary corresponding rolling bearing. The first transverse direction X corresponds to the circumferential direction. The second transverse direction Y corresponds to the radial direction.

### LIST OF REFERENCE NUMBERS

1 Cage part

3 Connecting part

4 First supporting arm

5 Second supporting arm

7 First half arm

8 Second half arm

9 Third half arm

10 Fourth half arm

12 Bending area

14 Contour element

15 Contour element

16 Contour element

19 Section, arc-shaped

20 Cage part

22 Reinforcement rib

30 Rolling bearing cage

40 Cage part

41 Rolling body

1. A cage part for a rolling bearing cage, comprising a connecting part that extends in a longitudinal direction (Z), with a first supporting arm and a second supporting arm that are arranged on ends of said connecting part and extend in a first transverse direction (X) perpendicular to the longitudinal direction (Z) beyond the connecting part on both sides, the supporting arms each comprise two half arms that are angled away from the connecting part opposite each other and are offset relative to each other in a second transverse direction (Y) perpendicular to the first transverse direction (X) and to the longitudinal direction (Z).

2. The cage part according to claim 1, wherein the half arms of the first supporting arm and the second supporting arm angled away in a same direction are offset relative to each other in the second transverse direction (Y).

3. The cage part according to claim 1, wherein a contour element extending in the longitudinal direction (Z) is formed on the half arms, and the contour elements of the half arms of the first supporting arm and the second supporting arm are oriented relative to each other.

4. The cage part according to claim 3, wherein a number of the contour elements extending in the first transverse direction (X) and arranged, in an alternating pattern, are formed on the connecting part.

5. The cage part according to claim 1, wherein the half arms have, along the first transverse direction (X), a length that is greater than a diameter of a rolling body to be held in the rolling bearing cage.

6. The cage part according to claim 1, wherein the half arms are bent away from the connecting part over a bending area.

7. The cage part according to claim 6, wherein the bending areas each extend in the longitudinal direction (Z) over a straight-line section of the connecting part and are bent back such that each of the bent half arms, projected in the first transverse direction (X), intersects the straight-line section of the connecting part.

8. The cage part according to claim 6, wherein a reinforcement rib is formed in the bending areas of the half arms.

9. The cage part according to claim 1, wherein the half arms are expanded by arc-shaped sections in the second transverse direction (Y), and the arc-shaped sections of the half arms of each of the supporting arms are arranged turned away relative to each other.

10. A rolling bearing cage with a plurality of cage parts according to claim 1, wherein the cage parts are arranged in series one after the other a the circumferential direction with an axial orientation of each of the connecting parts such that the half arms of the first supporting arm and the second supporting arm of adjacent cage parts are adjacent in a radial direction.
